(19) United States
(12) Patent Application Publication
(10) Pub. No.: US 2012/0006651 A1
(43) Pub. Date: Jan. 12, 2012

(54) ROBOTIC ROW COLLECTOR

(75) Inventor: Kevin Cote, Allen, TX (US)

(73) Assignee: FRITO-LAY NORTH AMERICA, INC., Plano, TX (US)

(21) Appl. No.: 12/834,350

(22) Filed: Jul. 12, 2010

(51) Int. Cl. B65G 47/46

(52) U.S. Cl. 198/468.6

(57) ABSTRACT

A method for collecting and orienting packages and a system for accomplishing the same. The invention describes a method for collecting and orienting packages on a system. The system comprises at least one arm coupled to at least one end effector. The end effector, in a pickup orientation, collects packages from an upstream conveyor. The arm then manipulates the end effector into a delivery position whereby the packages are deposited into a packaging chamber. The end effector can change the orientation of the packages so that they can be packaged in a container.

### BACKGROUND OF THE INVENTION

1. Technical Field

In one embodiment, the present invention relates to a system and method for collecting and orienting packages.

2. Description Of Related Art

Packages are often packaged via fixed automation whereby a series of conveyors, pulleys, etc. move, orient, and collect product to be packaged. Fixed automation has several disadvantages. First, fixed automation is not flexible. Packaging lines employing fixed automation are specifically designed to package a specific package; if a dissimilar package is going to be packaged then the fixed automation needs to be altered. Second, fixed automation is expensive as it is usually specially designed for the specific packaging line. Third, fixed automation often requires a large amount of floor or warehouse space. This is because fixed automation often relies on a series of conveyors which can necessitate a large footprint. Finally, packaging lines comprising fixed automation often have a capacity which is insufficient compared to the manufacturing lines. As a result, packaging lines utilizing fixed automation often must employ additional surge conveyors which can store the extra packages until the packaging line can package the product. Such surge conveyors are expensive and occur additional floor space.

Consequently, it is desirable to have packaging system which is flexible. It is desirable that a packaging system be able to package a wide variety of dissimilarly shaped packages. Further, it is desirable that the packaging system occupy minimal floor space. Finally, it is desirable that a packaging system eliminate the need for surge conveyors.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view in one embodiment of a system.

FIG. 2 shows a perspective view of an end effector in one embodiment.

FIG. 3A depicts a perspective view of one embodiment wherein the packages are in a stand-up orientation.

FIG. 3B shows a perspective view of packages being collected and oriented to be deposited in a stand-up orientation.

FIG. 4 is a perspective view of an end effector in one embodiment comprising partitions 401.

FIG. 5A illustrates a perspective view of one embodiment wherein the packages are in a side pack orientation.

FIG. 5B illustrates a perspective view of packages being collected and oriented to be deposited in a side pack orientation in one embodiment.

FIG. 6A is a perspective view of one embodiment wherein the packages have a plus orientation.

FIG. 6B is a perspective view of a first pickup orientation in one embodiment.

FIG. 6C is a perspective view of a second pickup orientation in one embodiment.

### DETAILED DESCRIPTION

Several embodiments of Applicant's invention will now be described with reference to the drawings. Unless otherwise noted, like elements will be identified by identical numbers throughout all figures.

Generally, one embodiment relates to a method and apparatus for collecting and packaging packages. The embodiment utilizes at least one robotic arm to collect packages in rows before depositing them into a packaging chamber.

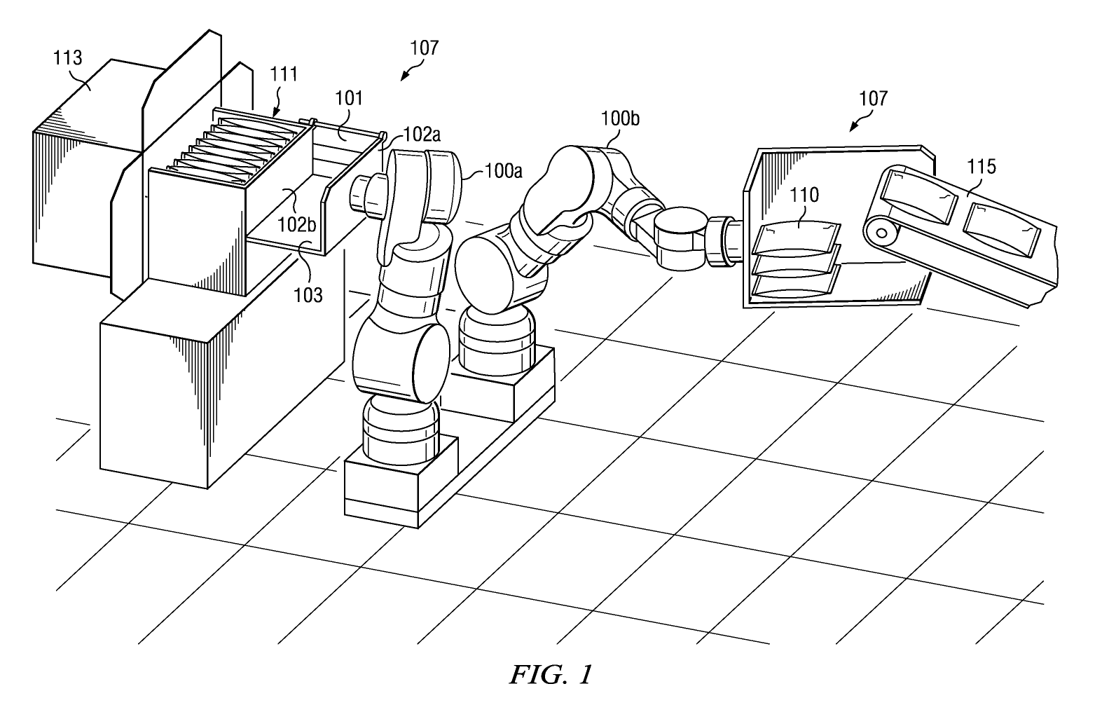

FIG. 1 is a perspective view in one embodiment of a system. As depicted, the system comprises two robotic arms 100a, 100b. In the operation depicted, one of the robotic arms 100b will be collecting packages 110 while the other robotic arm 100a is simultaneously depositing the packages into a packaging chamber 111. In this fashion, once the first arm 100b is full, the second arm 100a maneuvers to take the place of the first arm 100b. As such, the conveyor 115 can operate at a continuous speed. In one embodiment the conveyor 115 operates from about 200 to about 300 feet per minute. In one embodiment the conveyor 115 feeds product in the amount of about 50 to about 150 bags per minute. Such an operation decreases or eliminates the need for a so-called surge conveyor which acts as an intermediary to hold product before it is packaged. Thus, in one embodiment the system does not comprise a surge conveyor. As stated, previously the packaging systems could not keep up with the conveyor speed. By decreasing or eliminating the need for a surge conveyor substantial capital costs are saved. Further, available floor space is increased by removing the surge conveyor.

As depicted a first arm 100b is in the collecting position adjacent to the conveyor 115. The collecting position is any position wherein the end effector 107 can collect product from the conveyor 115. As used herein the term adjacent refers to any item which is next to, above, below, or in close proximity to another object. In one embodiment when the arm is in the collecting position, there is no equipment between the conveyor 115 and the end effector 107. As depicted, a second arm 100a is in the depositing position adjacent to the packaging chamber 111. The depositing position is any position wherein the end effector 107 can deposit product into a packaging chamber 111.

In one embodiment each arm can move independently between the collecting and depositing positions. In one embodiment the location of a first arm 100b is not dependent on the location of a second arm 100a. For example, in one embodiment a first arm 100b will be in the collecting position while the second arm 100a is not in a depositing position and is not in a collecting position. The second arm 100a can be in a transitional position whereby it is moving from a first position, such as a depositing position, to a second position, such as a collecting position. Likewise, the second arm 100a can take a position downstream from the end effector 107 of the first arm 100b so that when the first arm 100b is finished receiving the second arm 100a can take the collecting position.

The robotic arms 100a, 100b can comprise virtually any type of robotic arm known in the art. In one embodiment the robotic arm 100a, 100b can rotate along 7-axis. In one embodiment a robotic arm 100a, 100b comprising less than 7-axis can be utilized. In one embodiment a ZZ series articulated arm robot of Kawasaki Robotics, Inc. of Wixom, Mich. is utilized. In another embodiment the robotic arm is a SIA20 Robotic Arm made by Motoman, Inc. of West Carrollton, Ohio. Other suitable robotic arms include M-Series arms from Fanuc Robotics America, Inc. of Rochester Hills, Mich.

One benefit of the robotic arm is that it requires a relatively small foot print in which to operate. In one embodiment, two robotic arms simultaneously collect and deposit packages in a space of about four square feet. This decreases the amount of floor space required to perform this operation.

Coupled to the robotic arm 100a, 100b, is an end effector 107. The end effector 107 can comprise virtually any shape. In one embodiment the end effector 107 comprises at least three sides. The base side 102 is any side or portion of the end effector 107 which couples to the robotic arm 100a, 100b. The base 102 may be coupled to the robotic arm 100a, 100b by welding, via screws, bolts, or other such devices known in the art. In one embodiment the base 102 comprises a releasable attachment whereby the end effector 107 is releasably attached to the robotic arm 100a, 100b. This will allow other end effectors 107 of other shapes and sizes to be attached to the robotic arm 100a, b. Such an embodiment increases versatility. For example, a first end effector may be utilized to collect 4.5″ wide packages. This end effector may be replaced with a wider end effector to collect 7″ wide packages. Such a speedy transition reduces down time. Further, this versatility allows the same packaging system to be utilized with a wide variety of packages and packaging orientation. This is a benefit over the prior art which was customized for a specific package size and a specific orientation.

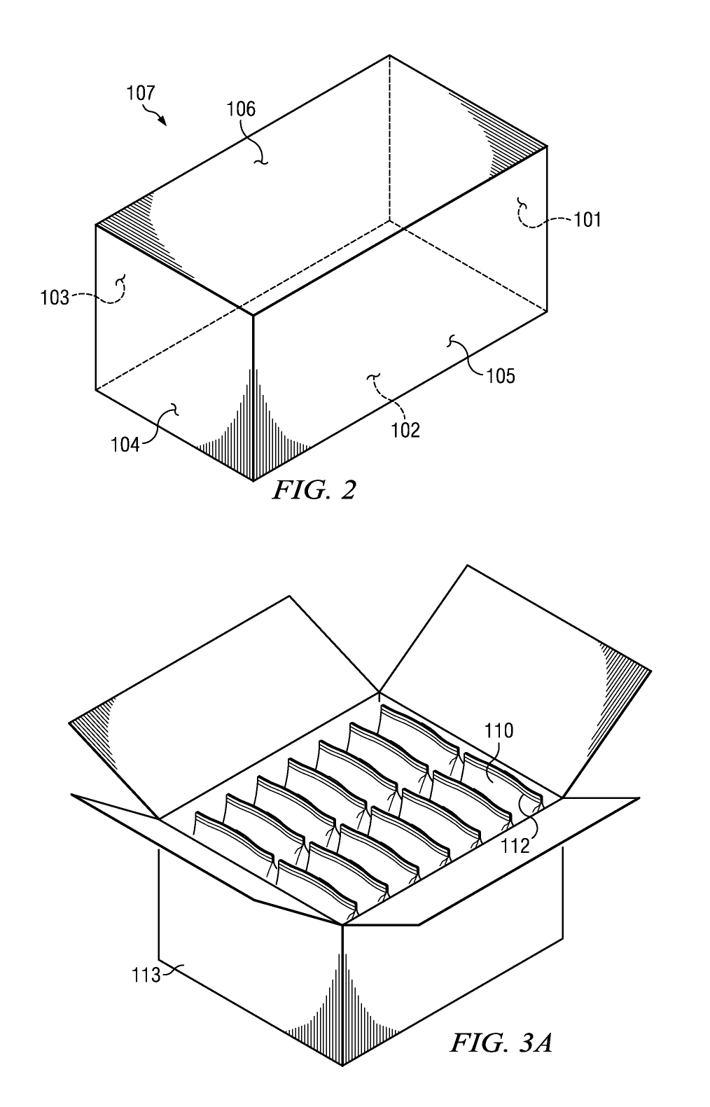

FIG. 2 shows a perspective view of an end effector in one embodiment. FIG. 2 is shown to define the possible side and side locations of a rectangular end effector 107 in one embodiment. As depicted, the end effector 107 comprises a base side 102 located in the base position. The position of a side refers to the side's orientation. Accordingly, if the end effector is rotated 180 degrees along a horizontal axis, then the base side 102 will be referred to as being in the top position. Regardless of its location, however, the base side 102 will still be referred to as the base side 102.

The end effector 107 may further comprise a top side 106 located in the top position which is opposite from the base side 102. As stated above, if the end effector 107 is rotated 180° along a horizontal axis, then the top side 106 will be in the base position.

The end effector 107 may further comprise a left side 104 located in the left position opposing a right side 101 located in the right position. As described above, if the end effector 107 is rotated 180° around a vertical axis, then the left side 104 is described as being in the right position. The end effector 107 may also comprise a front side 105 located in the front position opposing a back side 103 located in a back position. If the end effector 107 is rotated 180° around a vertical axis, then the back side 103 is described as being in the front position. As will be discussed herein, different embodiments will utilize various sides of the end effector 107. In some embodiments the end effector 107 may comprise only a single open side, whereas in other embodiments, the end effector 107 may comprise multiple open sides. An open side refers to a side position which does not comprise a closed side. For example, if the top side 106 were open, then the resulting end effector will comprise five closed sides and one open side, the top side 106. Packages would then be collected through the top open side 106. In such an embodiment, if the end effector 107 is rotated so that the top side 107 rotates to the base position, then the packages will fall from the end effector 107. However, if the end effector 107 is rotated so that the top side 107 is in the front position, then the orientation of the packages within the end effector have also been rotated. This will be discussed in more detail below.

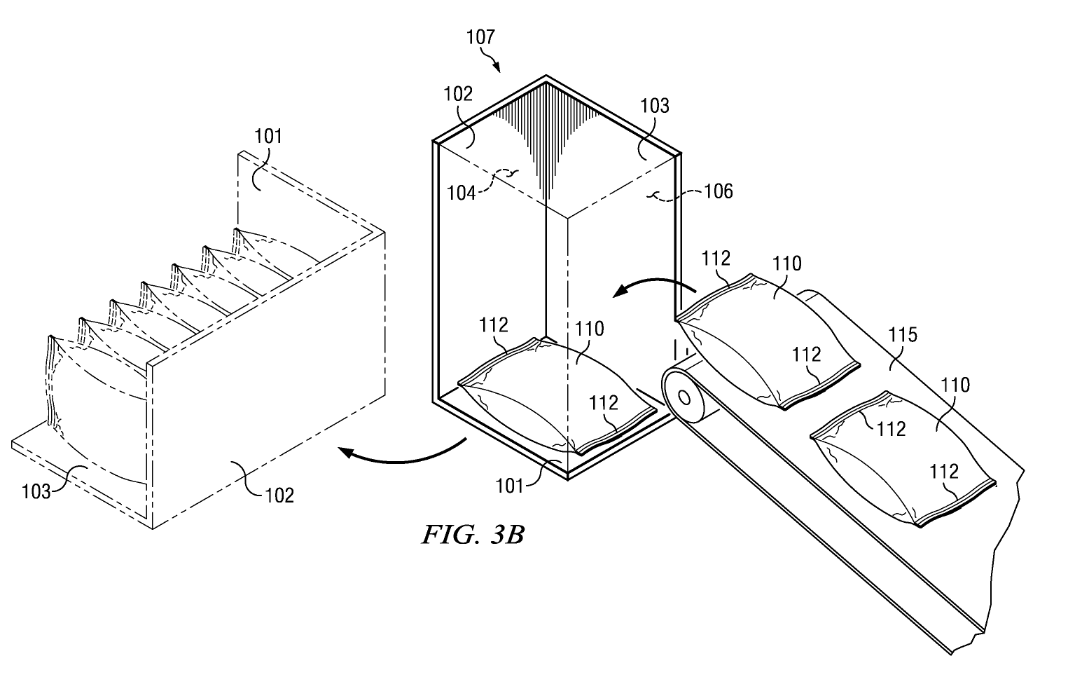

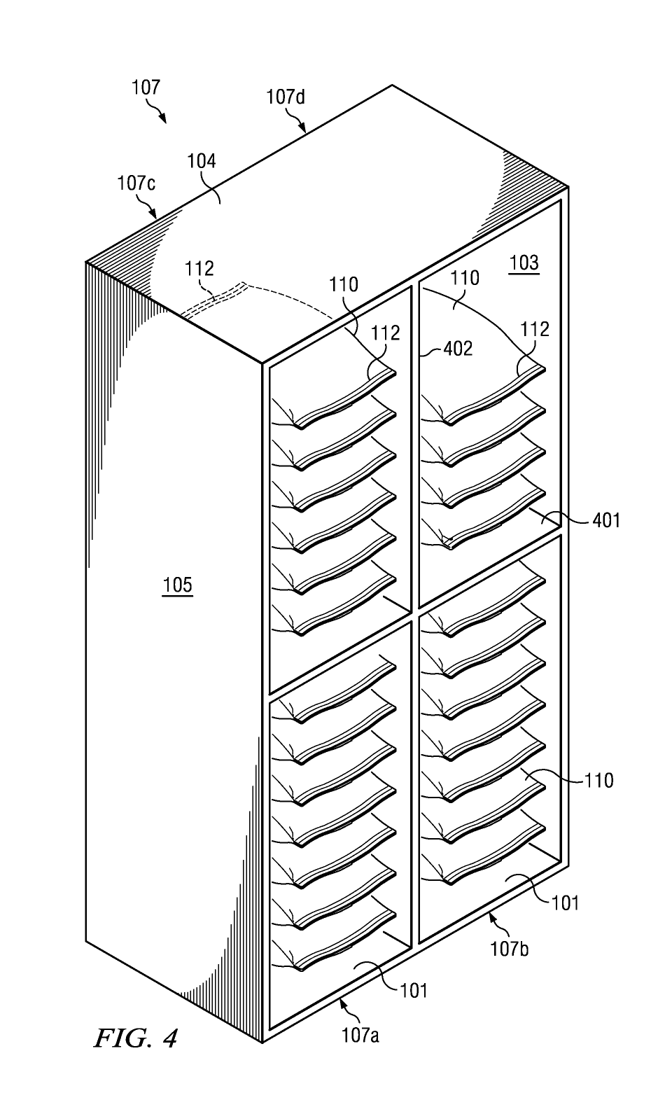

In other embodiments, the end effector 107 comprises more than one open side. As will be discussed, FIGS. 3, 5, and 6 illustrate an embodiment wherein the end effector 107 comprises a base side 102, a back side 103, and a right side 101. In such an embodiment the top side 106 located in the front position, the left side 104 located in the top position, and the front side 105 located in the left position are open.

In some embodiments the end effector 107 comprises stationary sides. In other embodiments, the sides comprise other features such as the ability to open, slide, raise, lower, etc. These will be discussed in detail below.

While one embodiment wherein the end effector 107 comprises at least three sides has been described the invention is not so limited. The end effector 107 can comprise a variety of shapes including circular, oval, cylindrical, triangular, rectangular, etc. In one embodiment the end effector 107 is shaped to complement the packaging container 111. In one embodiment the end effector 107 is shaped to mate with the packaging container 111. In one embodiment the end effector 107 is shaped to accommodate the packages 110. As an example, the package 110 may be cylindrical in shape. In such an embodiment the end effector 107 can be cylindrical in shape. As an example, the conveyor 115 may conveyor the cylindrical package 110 so that it is laying on its length. The end effector 107 can then reposition the package 110 so that it is standing on its base. In another embodiment the final container 113 can comprise a cylindrical shape. As such, it is desirable that the packages be arranged to form a cylindrical shape. In such an embodiment it may be desirable to have a cylindrically shaped end effector 107. Those skilled in the art will understand which shapes will be suitable for varying embodiments.

Referring back to FIG. 1, the system further comprises a conveyor 115. The conveyor 115 can comprise any conveyor known in the art. As depicted, the conveyor 115 conveys packages 110 into the end effector 107. In one embodiment the conveyor 115 feeds product in the amount of about 50 to about 150 bags per minute. Virtually any type of package 110 which is stored in rows may be utilized in this packaging system. Suitable packages include, but are not limited to, boxes, bags, discrete items such as books or magazines, milk cartons, soda bottles, pillow-pouch packages. Again, while the package 110 depicted is a pillow-pouch package, in other embodiments the package 110 comprises magazines, books, boxes, milk cartons, soda bottles, etc. In one embodiment the system is also suitable for breakable product such as food items or light bulbs. In one embodiment, the packages 110 comprise pillow-type snack food packages. In such embodiments, it is important to stack and handle the packages 110 so as not to break or damage the package contents.

The end effector 107 collects a specified amount of packages 110 and then deposits the packages 110 into a packaging chamber 111. A packaging chamber refers to any device which collects packages from the end effector and includes intermediate devices as well as the final containers. Thus, in one embodiment the packaging chamber 111 is the final container whereas in other embodiments the packaging chamber 111 comprises an intermediate device which prepares the package prior to being deposited into the final container. In one embodiment the packaging chamber 111 compresses the deposited packages 110 and then places the packages 110 into a container 113. The container 113 may be any suitable container and may comprise cardboard, plastic, etc. Virtually any shaped container of any material suitable for storage and/or shipping may be utilized.

In one embodiment the packaging chamber 111 takes all of the deposited packages 110 received from the end effector and places those packages in a container 113. In other embodiments, the packaging chamber 111 collects deposited packages 110 from at least two end effectors 107 before placing those packages in a container. In one embodiment the packaging chamber 111 collects packages from two separate end effectors 107. For example, in one embodiment the packaging chamber 111 collects a row of packages from one end effector 107 and then collects another row of packages from another, dissimilar end effector 107. The second row may be stacked upon the first row providing layers. Further, the second row may be stacked adjacent to the first row creating additional rows. In other embodiments the packaging chamber 111 collects packages from multi-passes from a single end effector. Thus, an end effector 107 will deposit an amount of packages into a packaging chamber 111 and will on a subsequent second pass deposit an additional amount of packages into the packaging chamber 111, wherein the packaging chamber 111 still contains packages from the first pass.

After a desired amount of packages has been collected, the packaging chamber 111 then deposits the packages 110 into a container. Accordingly, in one embodiment, the packaging chamber 111 acts as an intermediate storage device between the end effector 107 and the container. In other embodiments, however, the end effector 107 deposits the packages directly into the container 113.

Turning now to FIG. 3A, FIG. 3A depicts a perspective view of one embodiment wherein the packages are in a stand-up orientation. As can be seen the package 110 is standing on its bottom seal 112 such that the top seal 112 is visible. As depicted the container 113 comprises two rows of packages 110. As depicted each row comprises seven packages. In some embodiments the container 113 will have only a single row of packages, while in other embodiments the container 113 will comprise multiple rows of packages. In still other embodiments, the container 113 will comprise multiple layers. Layers can be formed by stacking rows upon one another. If the two rows of packages were stacked upon the two rows of FIG. 3A the resulting container will comprise two layers, each layer comprising two rows, and each row comprising seven packages for a total of 28 packages.

FIG. 3B shows a perspective view of packages being collected and oriented to be deposited in a stand-up orientation. In the figure, the packages 110 are being conveyed on a conveyor 115. As previously noted, the instant invention allows all packages to be delivered in a uniform orientation. The package is delivered lying on its front face with the end seals 112 being perpendicular to the direction of travel.

As depicted the packages 110 are being collected in an end effector which comprises three sides: a right side 101 located in the base position, a base side 102 located in the back position, and a back side 103 located in the right position. As depicted, the packages are being placed upon the right side 101 of the end effector 107. During collection, the end effector 107 is in the pickup orientation. A pickup orientation is an orientation of the end-effector which allows the end-effector to collect packages. Many different pickup orientations are possible. As will be discussed, in one embodiment multiple pickup orientations are used to collect packages. Referring briefly to FIG. 1, the pickup position of an end effector 107 is depicted on a first arm 100b in the collecting position.

Referring back to FIG. 3B, in the embodiment depicted, the packages enter the end effector 107 through the open top side 106 of the front position. As can be seen, the end effector 107 is positioned so that the right side 101 of the end effector is in the base position. Accordingly, packages stack upon the right side 101 of the end effector 107 along the length of the base side 102 and the back side 103. In one embodiment only a single package is collected in said end effector 107 whereas in other embodiments two or more packages are collected in a stacked orientation. The embodiment illustrated comprises an open left side 104, an open front side 105, and an open top side 106. Put differently, the front, top and left positions are open. In other embodiments, however, one or more of these sides may be closed. For example, in the embodiment depicted, the end effector may comprise a closed front and left position. In such an embodiment, the packages 110 would enter the end effector 107 through the open front position.

In one embodiment, as the end effector 107 receives a package 110 it lowers vertically relative to the conveyor 115. This ensures that each package 107 falls the same distance which minimizes potential breakage. Accordingly, when the end effector 107 is empty it is positioned at it highest point adjacent to the conveyor 115. As the end effector 107 receives packages 110 it incrementally lowers in height to receive subsequent packages. In one embodiment, the end effector 107 lowers in height by an amount approximately equal to the thickness of the package received on the end effector 107. As an example, if the package 110 being collected is 3 inches thick as measured against the vertical base side 102, then the end effector 107 will lower approximately 3 inches after receiving the first package 110.

After the desired amount of packages have been received by the end effector 107, the end effector 107 is manipulated into the delivery orientation. A delivery orientation is the orientation of the end effector when product is deposited into a packaging chamber. In one embodiment, the delivery orientation is dissimilar from the pickup orientation. In one embodiment the delivery orientation is the pickup orientation rotated 180° across a vertical plane. In other embodiments the delivery orientation has at least one side which has changed orientations relative to a horizontal plane compared to the pickup orientation. For example, in the pickup orientation one side will be parallel to a vertical plane whereas in the delivery orientation the same side will be parallel to a horizontal plane. Referring briefly to FIG. 1, FIG. 1 depicts an end effector 107 in the delivery orientation located on a second arm 102a in the depositing position.

Referring back to FIG. 3B, as depicted the delivery orientation comprises the back side 103 in the base position and the base side 102 in the front position. There are many different ways to manipulate the end effector 107 so that it changes from the pickup orientation to the delivery orientation. In one embodiment, the transition comprises a fluid movement whereby the end effector 107 is simultaneously tilted so that the back side 103 rotates to the base position.

When the end effector 107 is repositioned, the packages within the end effector are also repositioned. As can be seen, the packages 110 are initially stacked upon the face of the package 110. However, after repositioning the packages in the delivery orientation now sit upon the product edge. The product can then be placed into a packaging chamber 111 before being placed in a container 113. In one embodiment, the packages 110 are deposited in their delivery orientation into an open top end of the container 113. Thereafter, if two rows of product are placed into a container 113, and the container 113 is set upright, then the resulting package resembles the container 113 shown in FIG. 3A. In one embodiment all the packages are deposited simultaneously whereas in other embodiments the packages are not deposited simultaneously. In one embodiment wherein the packages are not deposited simultaneously, a comparatively smaller end effector may be utilized. In one embodiment a smaller end effector 107 facilitates a quick removal of package 110 from the end effector 107.

There are a variety of ways in which the packages 110 can be removed from the end effector 107. As previously discussed, the end effector 107 may deposit the products in a packaging chamber 111 which holds the packages or the packages can be deposited directly into a container. Referring back to FIG. 1, FIG. 1 shows an embodiment wherein the base side 102 slides outward to push the packages out of the end effector 107. In such an embodiment the end effector 107 comprises a moveable side 102b. A moveable side, as used herein refers to a side which has the ability to slide, move, tilt, open, raise, lower, rotate, etc. As shown, the moveable side 102b pushes the packages into the packaging chamber 111. The packaging chamber 111 then deposits the packages 110 into the container 113. It should be noted that while FIG. 1 depicts the base side 102 comprising the movable side 102b, the moveable side 102 can be located on any side. In other embodiments more than one side will comprise moveable sides allowing packages to be pushed in a variety of directions. The moveable side may be adjusted by hydraulics, chains, or other such methods known in the art. After the moveable side has pushed the packages it returns to its original position so that additional product may be received.

While FIG. 1 illustrates an embodiment wherein the package is pushed out, in other embodiments the package can be dumped or otherwise removed. For example, in one embodiment a side is removed to allow product removal. In one embodiment the side slides out of position. Referring to FIG. 1, if the back side 103 located in the base position slides outward then the packages 110 will fall via gravity to the desired destination below. In other embodiments the sides operate as doors which swing open. In still other embodiments, the packaging chamber 111 comprises a tool which mates with the end effector 107 and which pulls or rakes the product from the end effector 107.

As discussed above, if the single row end effectors 107 of FIG. 3B are stacked upon one another, then a container with multiple rows can be produced. FIG. 4 illustrates another embodiment wherein multiple rows of packages can be collected by a single end effector 107. FIG. 4 is a perspective view of an end effector 107 in one embodiment comprising partitions 401. The end effector 107 depicted in FIG. 4 is in the same pickup orientation as the end effector in FIG. 3B. The packages are collected upon the right side 101 in the base position through the open top side 101. Put differently, the packages enter the end effector 107 through the open front position. The end effector in FIG. 4 further comprises a closed front side 105 in the left position, a closed back side 103 in the right position, a closed right side 101 in the base position, a closed left side 104 in the top position, and a closed base side 102 in the back position.

Further, the end effector 107 comprises two partitions 401 which create four segments of end effectors 107a-d. The end effector now comprises a top left segment 107c, a top right segment 107c, a lower left segment 107a, and a lower right segment 107b. While the embodiment depicted has four segments, virtually any number of segments can be created.

The end effector 107 may be used as illustrated in FIG. 3B. In one embodiment, the end effector 107 generally fills from the bottom-up. Thus, the end effector 107 first collects packages in the lower segments 107a, 107b. In one embodiment it is faster to fill adjacent segments 107a, 107b simultaneously as opposed to one segment entirely before moving to the next. Put differently, in one embodiment a first segment is not completely filled before a second segment receives product. The reason is that such operation requires smaller progressive movements. For example, if the lower left segment 107a is to be filled completely, then the end effector 107 lowers slightly at that segment begins to fill. After the lower left segment 107a is full then the end effector 107 must quickly lower and align so that the lower right segment 107b aligns with the conveyor 115 and collects packages. Accordingly, the end effector 107 must be lowered by approximately the entire length of the lower left end effector segment 107a. Contrariwise, if the lower end effector segments 107a,b are filled simultaneously, then comparatively smaller adjustments are required. For example, in one embodiment one or more packages are placed in the lower left end effector segment 107a. Thereafter, the end effector 107 slightly raises and aligns with the conveyor 115 to receive product in the lower right end effector 107b. In such an embodiment, the end effector 107 only has to be raised by approximately the width of the number of received packages 110. Thereafter, the end effector 107 would receive a specified number of packages in the lower right segment 107b before moving back to fill the lower left segment 107a. After both lower segments 107a, 107b, are filled, the upper segments 107c, 107d align with the conveyor and begin to fill in the same method described above.

As can be appreciated, when filing the final package at the top of the top left segment 107c, for example, the package has a smaller entry area compared to the first package received. The entry area refers to the area of an open end of an end effector which may receive product. An empty end effector has a large entry area equal to the area of an open end of an end effector. However, when half of the end effector is filled with product then the available entry area is decreased by about half compared to an empty end effector. Put differently, when the first package is received the entry area was proportional to the length of the base side 102. However, after several packages are received, the entry area is proportional to the length of the base side 102 less the sum of the package widths. Accordingly, in one embodiment at least one of the sides of the end effector 107 comprises the ability to raise and lower to adjust the available entry area. For example, as depicted in FIG. 4, the left side 104 in the top position may comprise the ability to lift away from the end effector 107 which increases the entry area for the package. The side may lift completely away or it only an end of the side may lift offering several inches of additional entry space. In one embodiment the side lifts by an amount approximate to the width of the package being received. Additionally, the horizontal partition 401 may comprise the ability to lift to allow for additional entry space in the lower segments 107a, 107b.

After the end effector 107 depicted in FIG. 4 is full it is repositioned as desired to be deposited into either the packaging chamber 111 or the container. As stated previously one or more sides may comprise the ability to move, slide, open, etc. to allow removal of the packages. Likewise, the partitions may move, slide, open, etc. to permit removal of the packages. The contents of the end effector 107 may be utilized to fill a container comprising two rows of packages. Alternatively, two end effectors 107 can be utilized to fill a container comprising four or more rows of packages. Additionally, as previously discussed, the contents from two or more end effectors 107 may be stacked upon one another to fill a container comprising multiple layers.

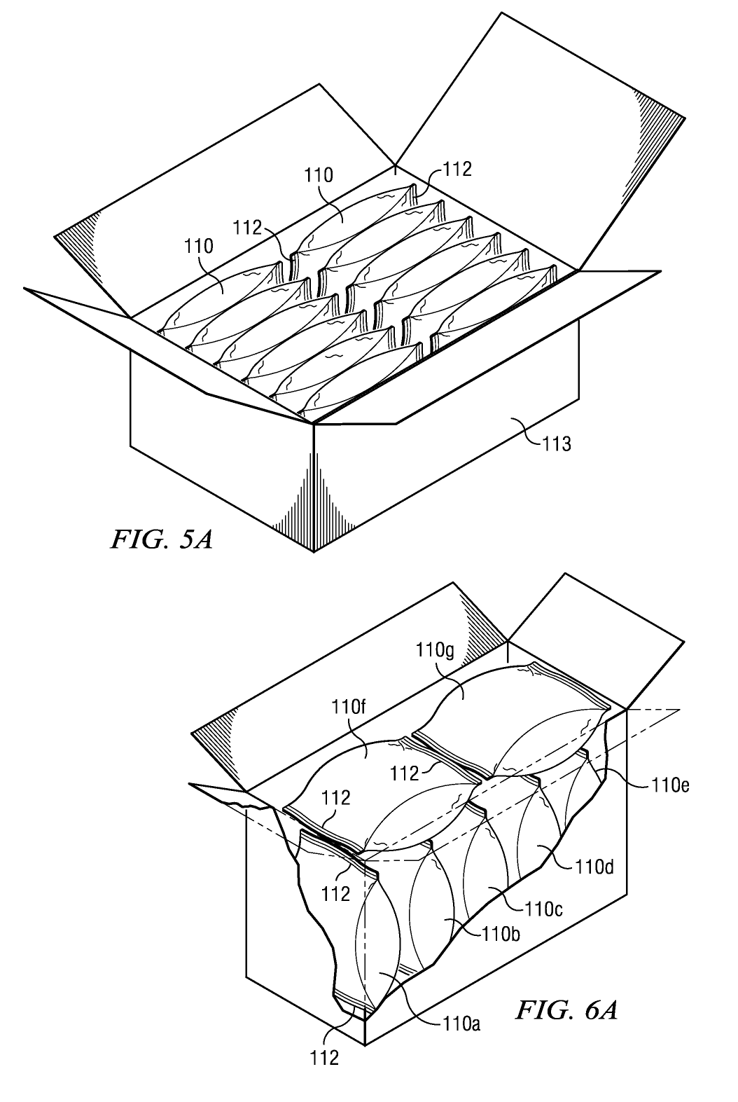

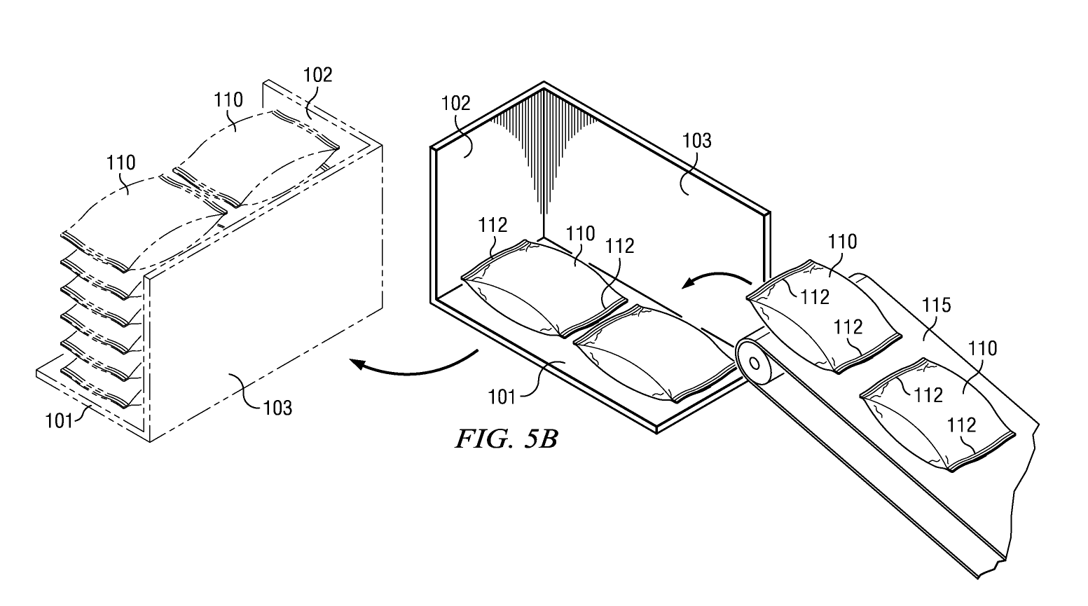

FIG. 5A illustrates a perspective view of one embodiment wherein the packages are in a side pack orientation. As can be seen from FIG. 5B, in such an orientation the packages are resting upon their edges and their end seals are parallel to a vertical plane.

FIG. 5B illustrates a perspective view of packages being collected and oriented to be deposited in a side pack orientation in one embodiment. As previously discussed, in one embodiment the packages 110 arrive from the conveyor in the same orientation as previously discussed. In the embodiment depicted the right side 101 is in the base position. The back side 103 is located in the right side position, and the base side 102 is located in the back position. As depicted, the front, top, and left positions are open. However, as previously discussed, in other embodiments the end effector 107 may comprise additional sides.

The end effector repositions to the delivery orientation by rotating about a vertical axis. Thereafter, the packages can be deposited into a packaging chamber 111 or a container. In one embodiment, the packages are placed in the top open end of the container such that when the container is rotated upright, the result will be the container 113 in FIG. 5B.

As shown in FIG. 5A, two rows of packages are obtained simultaneously. In operation, after a specified amount of packages are received the end effector 107 moves laterally relative to the conveyor in order to collect a specified number of packages in an adjacent row. The multiple row embodiment is illustrated for illustrative purposes only and should not be deemed limiting. The pickup and delivery orientations depicted in FIG. 5A are also suitable for single row embodiments.

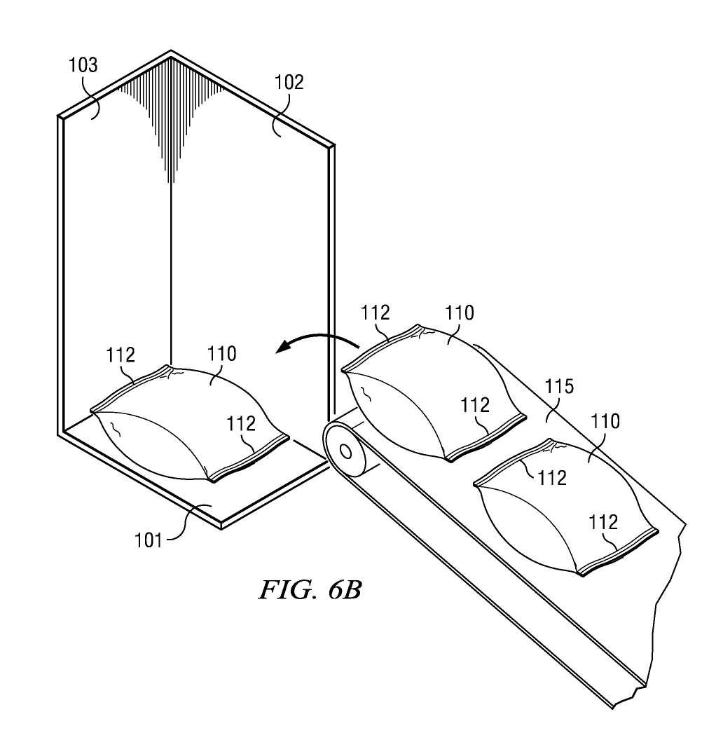

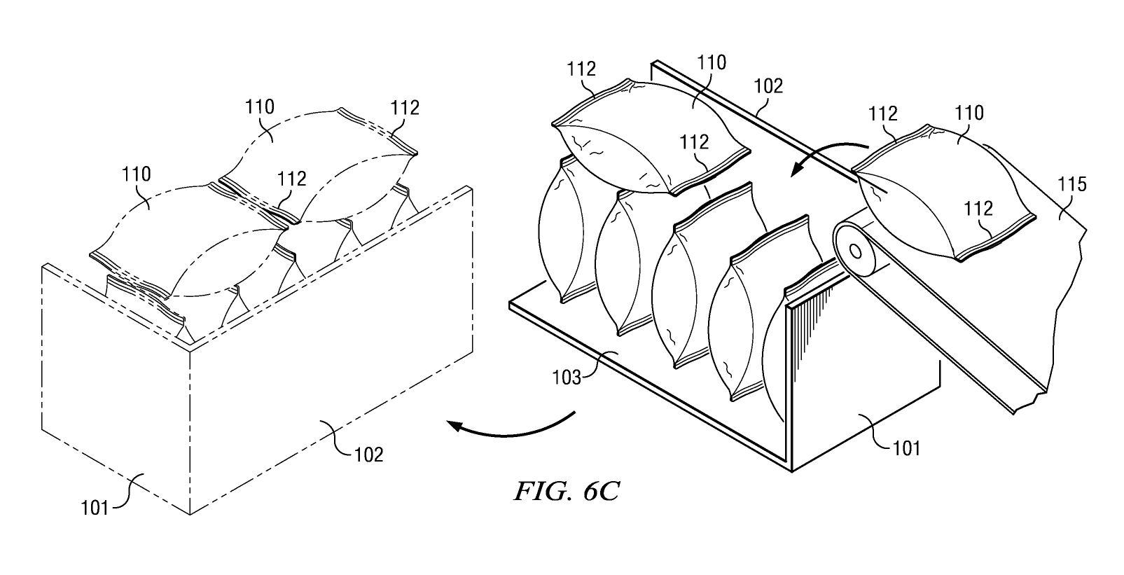

FIG. 6A is a perspective view of one embodiment wherein the packages have a plus orientation. A “plus orientation” as used herein refers to any orientation wherein a dissimilarly oriented product is stacked adjacent to another product. Often, the container 113 height is greater than the package height. In such an embodiment to maximize the number of packages within a given container, a single container may comprise packages comprising a variety of orientations. As depicted, the container in FIG. 6A has five packages oriented in the stand-up position, and two packages, located atop the five lower packages, oriented on their faces. While the figure only shows two upper packages, those skilled in the art will appreciate that this number is not limiting. Virtually any number of upper packages may be created in virtually any number of rows. For example, while the container 6A only comprises a single row, that row can be recreated, using the methods described herein, to result in a multi-row container.

In one embodiment, to obtain the “plus orientation,” two or more pickup orientations are utilized. One embodiment comprises a first pickup orientation and a second pickup orientation. In one embodiment, the first and second pickup orientations are dissimilar. In one embodiment the second pickup orientation has at least one side which has changed orientations relative to a horizontal plane compared to the first pickup orientation. For example, in the first pickup orientation one side will be parallel to a vertical plane whereas in the second pickup orientation the same side will be parallel to a horizontal plane. In some embodiments the second pickup orientation is the same as the delivery whereas in other embodiments the second pickup orientation is dissimilar from the delivery orientation.

FIG. 6B is a perspective view of a first pickup orientation in one embodiment. After the end effector 107 collects the specified number of packages, in this case five, the end effector 107 is repositioned to the second pickup orientation. FIG. 6C is a perspective view of a second pickup orientation in one embodiment. As can be seen, whereas packages were deposited on right side in the base position in the first pickup orientation, in the second pickup orientation the end effector 107 has been rotated so that the back side 103 is the base position and packages are deposited atop the previously deposited packages. The end effector 107 moves horizontally relative to the conveyor 115 to collect all the packages in the second pickup orientation. Thereafter, the end effector 107 is positioned to the delivery orientation whereby packages are deposited into either the packaging chamber 111 or a container.

The invention illustratively disclosed herein suitably may be practiced in the absence of any element which is not specifically disclosed herein. While the invention has been particularly shown and described with reference to a preferred embodiment, it will be understood by those skilled in the art that various changes in form and detail may be made therein without departing from the spirit and scope of the invention.

What is claimed is:

1. A system for collecting and orienting packages comprising:
a conveyor;
at least one arm located downstream from said conveyor,
at least one end effector comprising a base side, and wherein said end effector is coupled to said at least one arm at said base side;
a packaging chamber located downstream from said at least one arm.

2. The system of claim 1 wherein said at least one arm comprises two arms, a first arm, and a second arm.

3. The system of claim 2 wherein said first arm is in a collecting position adjacent to said conveyor, and wherein said second arm is in a depositing position adjacent to said packaging chamber.

4. The system of claim 3 where said first and second arm can each independently move between said collecting position and said depositing position.

5. The system of claim 3 wherein there is no equipment between the conveyor and the end effector on said first arm.

6. The system of claim 3 wherein said end effector is in a first pickup orientation when said first arm is in said collecting position and wherein said end effector is in a delivery orientation when said second arm is in said depositing position.

7. The system of claim 6 wherein said end effector comprises at least one side, and wherein when said end effector is in said delivery orientation said end effector has at least one side which has changed orientations relative to a horizontal plane compared to said first pickup orientation.

8. The system of claim 1 wherein said at least one arm is capable of offering at least two different pickup orientations.

9. The system of claim 1 wherein said at least one arm is capable of offering at least two different delivery orientations.

10. The system of claim 1 wherein said system does not comprise a surge conveyor.

11. The system of claim 1 wherein said at least one arm is rotatable along seven axis.

12. The system of claim 1 wherein said end effector comprises at least one moveable side.

13. The system of claim 1 wherein said end effector comprises partitions.

14. The system of claim 1 wherein said end effector moves vertically relative to said conveyor.

15. The system of claim 1 wherein said packaging chamber comprises a container.

16. The system of claim 1 wherein said end effector is coupled to said at least one arm via a releasable attachment.

17. The system of claim 1 wherein said end effector comprises at least three sides, wherein one of said three sides comprises a base side.

18. A method for collecting and orienting packages on a system, said system comprising:
at least one arm coupled to at least one end effector;
wherein said end effector comprises a base side, and wherein said end effector is coupled to said arm at said base side;
a conveyor for conveying, said conveyor located upstream of said arm;
a packaging chamber, said chamber located downstream of said arm;
wherein said method comprises:
a) conveying at least one package on a conveyor;
b) orienting said end effector into a first pickup orientation;
c) collecting at least one of said packages in said end effector;
d) manipulating said arm so that said end effector is positioned into a delivery orientation; wherein said delivery orientation is dissimilar from said first pickup orientation;
e) depositing said at least one of said packages into a packaging chamber.

19. The method of claim 18 wherein said at least one arm comprises two arms, and while a first arm is performing said collecting step a second arm is simultaneously performing said depositing step.

20. The method of claim 18 wherein conveying step comprises conveying at a constant speed.

21. The method of claim 18 wherein said conveying step comprises conveying product in a uniform orientation.

22. The method of claim 18 wherein said collecting step comprises lowering said end effector vertically relative to said conveyor after collecting each package.

23. The method of claim 18 wherein said end effector comprises at least two segments, and wherein said collecting step comprises collecting a specified number of packages in a first segment and then collecting a specified number of packages conveying product in a second segment.

24. The method of claim 23 further comprising collecting a specified number of packages in a first segment.

25. The method of claim 18 wherein during said collecting step a first segment is not completely filled before a second segment collects product.

26. The method of claim 18 wherein said end effector comprises at least two segments, a left segment and a right segment, and wherein said collecting step comprises adjusting said end effector so that said left segment aligns with the conveyor and collects product, and then adjusting said end effector so that said right segment aligns with the conveyor and collects product.

27. The method of claim 18 wherein said end effector comprises at least two segments, a top segment and a bottom segment, and wherein said collecting step comprises adjusting said end effector so that said top segment aligns with said conveyor and collects product, and then adjusting said end effector so that said bottom segment aligns with said conveyor and collects product.

28. The method of claim 18 wherein said end effector comprises at least two upper segments and at least two lower segments, wherein said collecting step comprises collecting a specified number of packages in said at least two lower segments before collecting any packages in said at least two upper segments.

29. The method of claim 18 wherein said end effector comprises at least one moveable side.

30. The method of claim 29 wherein during said collecting step said at least one moveable side moves to increase the available entry space.

31. The method of claim 18 further comprising:
f) orienting said end effector into a second pickup orientation;
g) collecting a quantity of said packages in said end effector.

32. The method of claim 31 wherein said steps f) and g) are performed prior to steps d) and e).

33. The method of claim 31 wherein said end effector comprises at least one side, and wherein in said orienting of step f) said second pickup orientation has at least one side which has changed orientations relative to a horizontal plane compared to said first pickup orientation.

34. The method of claim 1 further comprising:
g) packing said products into a container.

35. The method of claim 34 wherein said packing step comprises the packaging chamber collecting packages from at least two end effectors before packing said products into a container.

36. The method of claim 18 wherein said depositing step comprises depositing packages from at least two end effectors into said packaging chamber.

37. The method of claim 36 wherein packages deposited from one end effector are stacked adjacent to packages deposited from another end effector.

38. The method of claim 36 wherein packages deposited from one end effector are stacked upon packages deposited from another end effector.

39. The method of claim 36 wherein said at least two end effectors comprise two dissimilar end effectors.

40. The method of claim 36 wherein said at least two end effectors comprise multi-passes from a single end effector.

41. The method of claim 18 wherein said collecting step comprises collecting at least two packages in a stacked orientation.

42. The method of claim 18 wherein said depositing comprises moving a moveable side.

43. The method of claim 18 wherein said depositing step comprises depositing said packages into a packaging chamber, wherein said packaging chamber comprises a container.

44. The method of claim 18 wherein said end effector comprises at least one side, and wherein in said manipulating step said delivery orientation has at least one side which has changed orientations relative to a horizontal plane compared to said pickup orientation.

45. The method of claim 18 wherein said end effector comprises at least three sides.
